(19) United States
(12) Patent Application Publication
(10) Pub. No.: US 2003/0112971 A1
(43) Pub. Date: Jun. 19, 2003

(54) Method for generating a desired state of a pseudorandom sequence and a radio using same

(75) Inventors: Zhuan Ye, Buffalo Grove, IL (US); Anthony Schooler, Bartlett, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/022,553

(22) Filed: Dec. 17, 2001

(51) Int. Cl. H04L 9/00

(52) U.S. Cl. 380/46; 380/252

(57) ABSTRACT

One or more masks comprising pseudorandom sequence generating polynomials are utilized to derive new polynomials to thereby minimize the number of polynomials that need be stored to support use of pseudorandom sequences. The polynomials each correspond to a given state of a pseudorandom sequence and derivation of a particular such polynomial will allow calculation of the corresponding given state. A radio (85) in a code division multiple access wireless communications system (80) uses this approach to achieve rapid phase correlation with a pseudorandom sequence that is used by the system to facilitate synchronization.

### TECHNICAL FIELD

This invention relates generally to pseudorandom sequences and more particularly to generating a particular state of a pseudorandom sequence as well as application in a radio.

### BACKGROUND

Pseudorandom sequences are known in the art. Pseudorandom number sequences, for example, are frequently used in encryption applications and are also finding increasing applications in wireless communications. For example, in code division multiple access communication systems, the digitized data stream will be spreaded with pseudorandom number codes before transmission. The receiver can despread the digital data stream by applying the same pseudorandom number code as used by the transmitter. To facilitate this, however, the transmitter and receiver must be synchronized with respect to the pseudorandom number sequence. Achieving such synchronization can be particularly challenging when a mobile communications unit shifts from a first base station to a second base station. Although the base stations of a given communications system will typically use the same pseudorandom number sequence, this sequence will be offset in time from one base station to another. Therefore, when switching to a new base station, a mobile communications unit must newly establish synchronization of the pseudorandom number sequence.

In such a communications system, the generator of a pseudorandom number sequence can have, for example, 15 digits. The number of possible states that such a sequence can attain is 2^{N-1}, where N equals the number of digits in the sequence generator. Therefore, in such a system, there are 32,767 possible states. Adjacent base stations are often offset by a known number of subsequent states from one another. When switching to any given base station, therefore, the mobile communications unit need not attempt all 32,767 possible states to locate the desired state by trial and error. Nevertheless, even though the state offset is likely known, the corresponding phase of the pseudorandom number sequence must still be ascertained.

Each state of the pseudorandom number sequence can be calculated by a corresponding pseudorandom sequence generating polynomial (also often referred to as a mask). Some prior art solutions simply propose storing in memory the specific mask for each possible state of a given pseudorandom number sequence. As depicted in FIG. 1, this approach will result in a mask 1 being stored to calculate a corresponding state S1, a mask 2 being stored to calculate a corresponding state S2, and so forth. When the number of states is relatively large, this can require unfeasible amounts of memory (especially for a portable communications device).

Another prior art approach is depicted in FIG. 2. In this approach, not every potential state has a corresponding mask stored for it. Instead, masks for corresponding states are equally distributed throughout the sequence of potential states. For example, when working with a number like 32,767, a not uncommon spacing would be 64 states. Therefore, as depicted, a mask 2 would be provided to derive state S64 and another mask 3 would be provided 64 spaces later to derive state S128 (and so forth throughout the sequence). This approach allows calculation of a state that is within 32 states of any target state within the sequence. A next-state mask (in the example shown this would be mask 1) could then be utilized to incrementally calculate each succeeding next state until the target state has been reached. While this approach has significantly reduced memory requirements (only 513 masks need be stored as versus 32,767), significant processing time is potentially required. This calculation time can be critical, and particularly when seeking to synchronize to a moving target as exists in a communications system as referenced above.

A need therefore exists for a way to relatively quickly and reliably move from a first state of a pseudorandom sequence to a second potentially arbitrary state without requiring undue dedicated memory and while minimizing processing requirements. Preferably, the solution should be amenable to implementation in either a hardware based or software based embodiment.

### BRIEF DESCRIPTION OF THE DRAWINGS

These needs and others are substantially met through provision of the method for calculating a desired state of a pseudorandom sequence as disclosed below. These benefits and others will become more clear upon making a thorough review and study of the following detailed description, particularly when studied in conjunction with the drawings, wherein:

FIG. 1 comprises a prior art depiction of a first mask storage scheme;

FIG. 2 comprises a prior art depiction of a second mask storage scheme;

FIG. 3 comprises a flow diagram configured in accordance with various embodiments of the invention;

FIG. 4 comprises a detailed flow diagram configured in accordance with various embodiments of the invention;

FIG. 5 comprises a diagrammatic depiction of one embodiment of a mask storage scheme configured in accordance with the invention;

FIG. 6 comprises a diagrammatic depiction of mask derivation in accordance with various embodiments of the invention;

FIG. 7 comprises a schematic representation of mask calculation using multiple mask extrapolation in accordance with various embodiments of the invention; and

FIG. 8 comprises a system level diagrammatic depiction of a radio communications system having a radio configured in accordance with various embodiments of the invention.

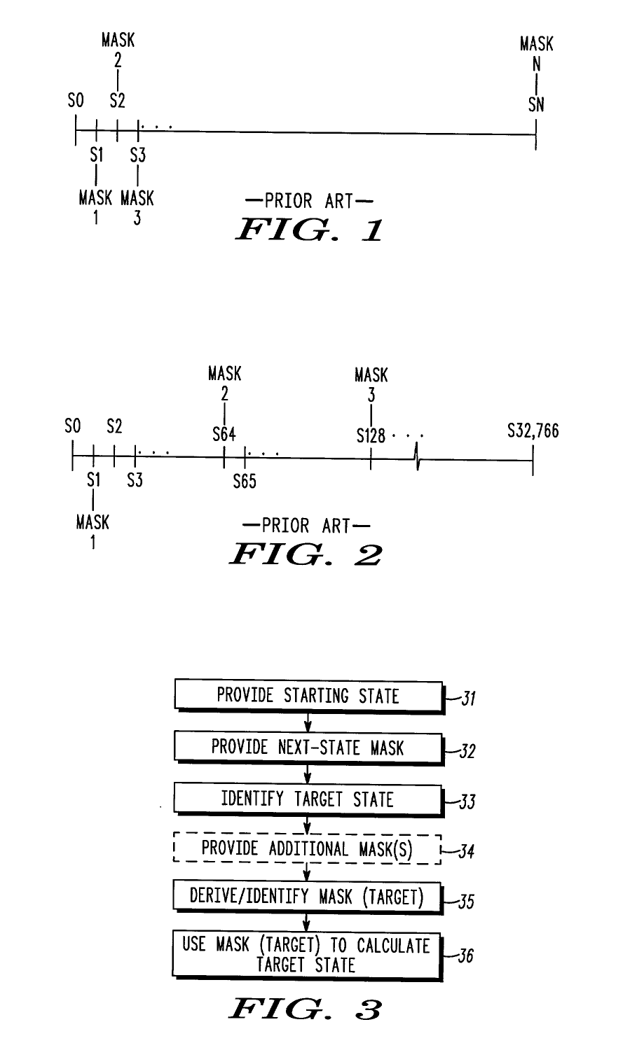

### DETAILED DESCRIPTION

Pursuant to the various embodiments presented below, only a few masks comprising pseudorandom sequence generating polynomials need be initially stored in order to permit rapid and efficient derivation of any given mask as required to calculate any given pseudorandom sequence state (as will be shown below, if desired only one initial mask need be originally stored). These various embodiments utilize one or more existing masks to generate a new mask that is capable of calculating a state that is closer (or equal) to the target state than any of the existing masks. This process can be iterated to move progressively closer to the target state as required. Though the masks can be equally distributed across the potential states as is done in some prior art approaches, in fact superior performance should ordinarily be expected by an unequal distribution. As will be seen below, in one embodiment a more or less logarithmic distribution provides satisfactory performance.

As a result, memory requirements are dramatically minimized while computational requirements are either no worse or often favorably impacted.

Referring now to FIG. 3, an overall description of basic activities in accordance with various embodiments of the invention will now be described. To begin, a starting state for a pseudorandom sequence of the items (wherein the items can be numbers such as binary 1's and 0's), wherein the pseudorandom sequence of items has a corresponding finite number of potential states (for purposes of this description, the pseudorandom sequence of items will be presumed to have 32,767 potential states though it should be understood that the invention has application for any number of finite potential states) is provided 31. For example, within the context of a wireless communications system, the starting state would likely be the present state of the pseudorandom sequence.

A next-state mask is also provided 32. The next-state mask comprises a pseudorandom sequence generating polynomial that determines the next state of the pseudorandom sequence. For example, if the present state is state X (where X simply represents any given state within the finite number of potential states for the pseudorandom sequence), the next-state mask will calculate state X+1. Such next-state masks are well understood and commonly used in the prior art. This particular mask has importance in part because the shift to a next adjacent subsequent state comprises the finest resolution move that is possible.

The target state (that is, the subsequent state of the pseudorandom sequence that is presently desired) must be identified 33. In many applications, this simply requires adding a known offset to the starting state. For example, if the present state is state X and if the known offset is 64 than the target state would be state X+64. More particularly, this target state represents the state of the pseudorandom sequence after the next-state mask has been iterated 64 times. Again, however, one benefit of these embodiments is that such a target state can be achieved without requiring 64 successive iterations.

Other masks in addition to the next-state mask can be provided 34 as well. It should be understood that the target state could be attained even though only the next-state mask were initially provided, and therefore the provision 34 of an additional mask or masks is optional. For most applications, however, providing additional masks will significantly reduce the time required to resolve to the target state. Importantly, the number of additional masks need not be large. For example, if the pseudorandom sequence has 32,767 potential states, 5 to 15 additional masks will readily facilitate the process (particularly if selected appropriately). The additional masks can be selected with corresponding relative state locations positioned anywhere within the finite number of potential states for the pseudorandom sequence. The additional masks can be selected, for example, to correspond to state locations that are evenly spaced throughout the potential states. Preferably, however, the additional masks are distributed more unevenly throughout the finite number of potential states for the pseudorandom sequence. Additional explanation and illustrations will be provided below regarding selection of specific additional masks.

With knowledge of the starting state and the target state, and with at least one initially provided mask, a mask(target) that will correspond to the target state is derived 35 (or identified if the necessary polynomial turns out to already be available). The mask(target) is derived 35 by combining other masks (when only one mask is available, then that mask can be combined with itself. By using this approach (which will typically require more than one iteration as will be shown below) any mask as will derive any state within the finite number of potential states for the pseudorandom sequence can be derived. By appropriate selection of the initial masks, relatively quick resolution with relatively few iterations can be ordinarily expected.

Once the mask(target) has been derived 35 (or again, identified if it already exists and does not need derivation) it can be used 36 to calculate the desired target state. By needing only a few originally provided masks to efficiently work a relatively large number of potential states, the memory requirements to support this process are greatly reduced as compared to prior art approaches. Furthermore, the number of iterations required to reach the mask(target) are not unduly large as compared to prior art approaches, and with appropriately selected initial masks can actually be less than competing solutions.

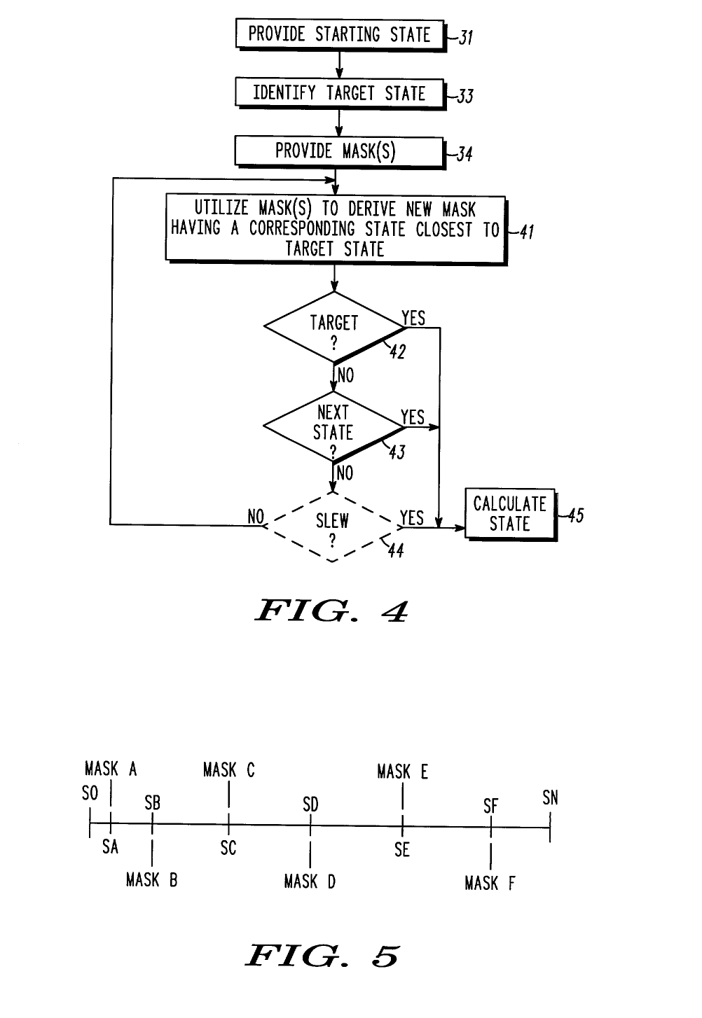

Referring now to FIG. 4, additional details regarding various embodiments to support this process will be described. As related above, a starting state is provided 31 and a target state is identified 33. The masks are then provided 34. As noted above, a single mask can be provided if desired (when only using a single mask, the next-state mask is a natural choice; nevertheless, other masks could be utilized as well). More typically, however, multiple masks are provided 34. As noted above, these masks are preferably unevenly distributed with respect to the potential states. With momentary reference to FIG. 5, the masks can correspond to states in a way that approximates or equals a logarithmic distribution. Accordingly, as depicted in FIG. 5 (which illustrates general relationships but is not drawn to scale), the space between state SA and state SB (and hence the number of states between state SA and state SB) is smaller than the space between state SB and state SC. In a similar fashion, the number of states separating subsequent selected states (such as state SD and state SE) increases as well. A preferred, but not required approach, is to space at least the wider gaps as an approximation of a logarithmic distribution (states associated with smaller gaps tend to be less useful and hence strict observation of a logarithmic distribution for smaller values can often be dispensed with without undue degradation of performance). By providing masks that will derive these selected states (such as mask A to derive state SA and mask E to derive state SE) a highly usable group of masks can be provided 34. Again, 5 to 15 well chosen masks will readily suffice to facilitate resolving towards any specific state within a sequence having 32,767 potential states.

As generally described with reference to FIG. 3, the provided mask or masks are utilized to derive the required mask(target). Usually, it will be unlikely that the mask(target) can be derived in a single iteration. The likelihood of being able to achieve a single iteration success will increase as the number of available masks increases. Since this process can resolve relatively quickly when using only a few masks, however, greatly increasing the number of available masks in order to more likely ensure a single iteration derivation will usually not provide any significant advantage. Therefore, multiple iterations are likely.

The available masks are therefore utilized 41 to derive a new mask having a corresponding state that is relatively closer to the target state. Preferably, the masks are utilized in a way to allow derivation of a new mask or selection of an existing mask that will represent a corresponding state that is closest to the target state.

Once a mask has been derived or otherwise selected, the process can determine 42 whether the resultant mask in fact represents the mask(target). If true, the corresponding state can be calculated 45 and the process concluded. If the resultant mask comprises an interim mask but does not represent the mask(target), the process can determine 43 whether one or more next-state executions will suffice to calculate the target state. If true, the next-state polynomial can be utilized to close a small remaining gap. Optionally, the process can also determine 44 whether slewing should be utilized to achieve the desired target state (slewing is a well understood process whereby two slightly unsynchronized pseudorandom sequences can be brought into synchronicity). If appropriate, slewing can be utilized to calculate 45 the target state. Otherwise, the process will iterate and once again utilize the masks to derive a new mask (each successive iteration can also utilize earlier derived masks in addition to the originally provided masks, thereby providing increasing variety and opportunity for rapid closure).

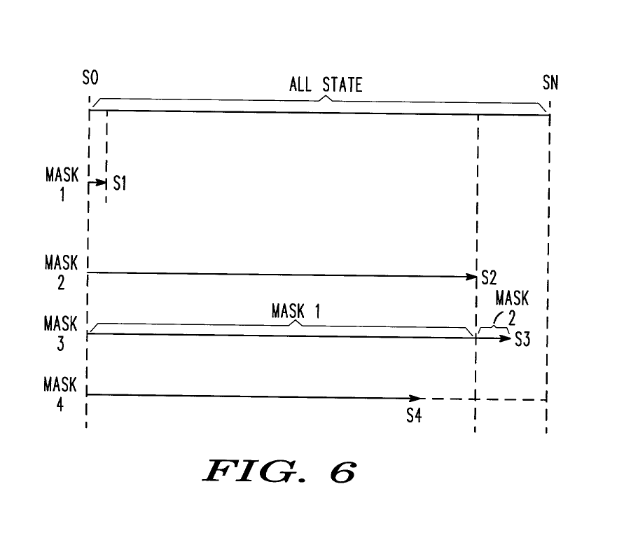

FIG. 6 may help illustrate the combining of masks to derive a new mask. All possible states for a given pseudorandom sequence are illustrated as existing between an original state SO and a last state SN. A first mask MASK 1 comprises a next-state mask and therefore represents movement to a next state (in this example, state S1). MASK 2 will calculate a state S2 that is greatly removed from the original state. MASK 3 represents a mask that would result by combining MASK 1 with a MASK 2. MASK 4 represents a mask that would result by combining MASK 3 with itself (note that upon reaching the last state SN the series of states simply begin again with the initial state SO), which new mask will calculate a corresponding state S4.

It can therefore be seen that one or more masks can be combined with themselves or other masks to thereby derive new masks. These new masks can be utilized to calculate corresponding new states of the pseudorandom sequence.

A very common way to represent a unique pseudorandom number sequence generator is to use the generation polynomial:

f(x)=x^{N}+g_{N-1}x^{N-1}+g_{N-2}x^{N-2}+ . . . +g₁x+1 (1)

An equivalent linear recursive representation (sometimes known as a Fibonacci representation) can be written as:

$$i ( n + N ) = {\sum }_{k = 0}^{N - 1} {g}_{k} i ( n + k ) = \vec{G} \cdot {\vec{I}}_{n} \qquad ( 2 )$$

Where \vec{G}={g_{N-1}, g_{N-2}, . . . , g₁, g₀}, \vec{I}ₙ={i(n+N−1), i(n+N−2), . . . , i(n+1), i(n)} and ● stands for inner product operation between two vectors. The secondary output of the pseudo random number sequence generator, with an arbitrary P-chip (also often referred to as bit or state) (P>N) offset, can be generated using the shift-and-add property of pseudo random number sequence, i.e.:

$$i ( n + p ) = {\sum }_{k = 0}^{N - 1} {p}_{k} i ( n + k ) = {\vec{M}}_{p} \cdot {\vec{I}}_{n} \qquad ( 3 )$$

Where the offset p is referenced to the output state i(n). This denotes {g_{N-1}, g_{N-2}, . . . , g₁, g₀} as a mask vector \vec{M}ₚ constructed by pₖ(k=0, . . . , N−1) from the above equation. (Computing these elements of a mask vector for an arbitrary offset is helpful for facilitating synchronization by a spread spectrum receiver.)

Similarly, by replacing p with p+1, one determines:

$$\begin{matrix}i ( n + p + 1 ) = {\sum }_{k = 0}^{N - 1} {p}_{{k}^{i}} ( n + k + 1 ) = {p}_{N - {1}^{i}} ( n + N ) + {\sum }_{k = 0}^{N - 2} {p}_{{k}^{i}} ( n + k + 1 ) \\ = {p}_{N - 1} {\sum }_{k = 0}^{N - 1} {g}_{{k}^{i}} ( n + k ) + {\sum }_{k = 1}^{N - 1} {p}_{k - {1}^{i}} ( n + k ) \\ = {\sum }_{k = 1}^{N - 1} ( {p}_{N - 1} \cdot {g}_{k} + {p}_{k - 1} ) \cdot i ( n + k ) + {p}_{N - 1} \cdot {g}_{0} \cdot i ( 0 ) \\ = {\vec{M}}_{p + 1} \cdot {\vec{I}}_{n}\end{matrix} \qquad ( 4 )$$

We can calculate \vec{M}ₚ₊₁ through the following equation:

\vec{M}ₚ₊₁=(\vec{M}ₚ<<1)+p_{N-1}·\vec{G} (5)

The above approach constitutes a single extrapolation mechanism as often appears in prior art technique. It is this mechanism that allows calculation of a mask that derives a state with one extra offset.

Now, let's replace p with another offset q. Using a similar Fibanacci representation as before, this yields:

$$i ( n + q ) = {\vec{M}}_{q} \cdot {\vec{I}}_{n} = {\sum }_{k = 0}^{N - 1} {q}_{{k}^{i}} ( n + k ) \qquad ( 6 )$$

Now let r=p+q. i(n+r) can be derived from:

$$\begin{matrix}i ( n + p + q ) = {\sum }_{k = 0}^{N - 1} {q}_{k} i ( n + p + k ) \\ = {\sum }_{k = 0}^{N - 1} {q}_{k} \cdot ( {\vec{M}}_{p + k} \cdot {\vec{I}}_{n} ) \\ ⇒ {\vec{M}}_{p + q} = {\sum }_{k = 0}^{N - 1} {q}_{k} \cdot {\vec{M}}_{p + k}\end{matrix} \qquad ( 7 )$$

Where \vec{M}_{p+q} constitutes mask vectors with offsets p+1, p+2, . . . , p+N−1 respectively and can be easily calculated via the single extrapolation method described above.

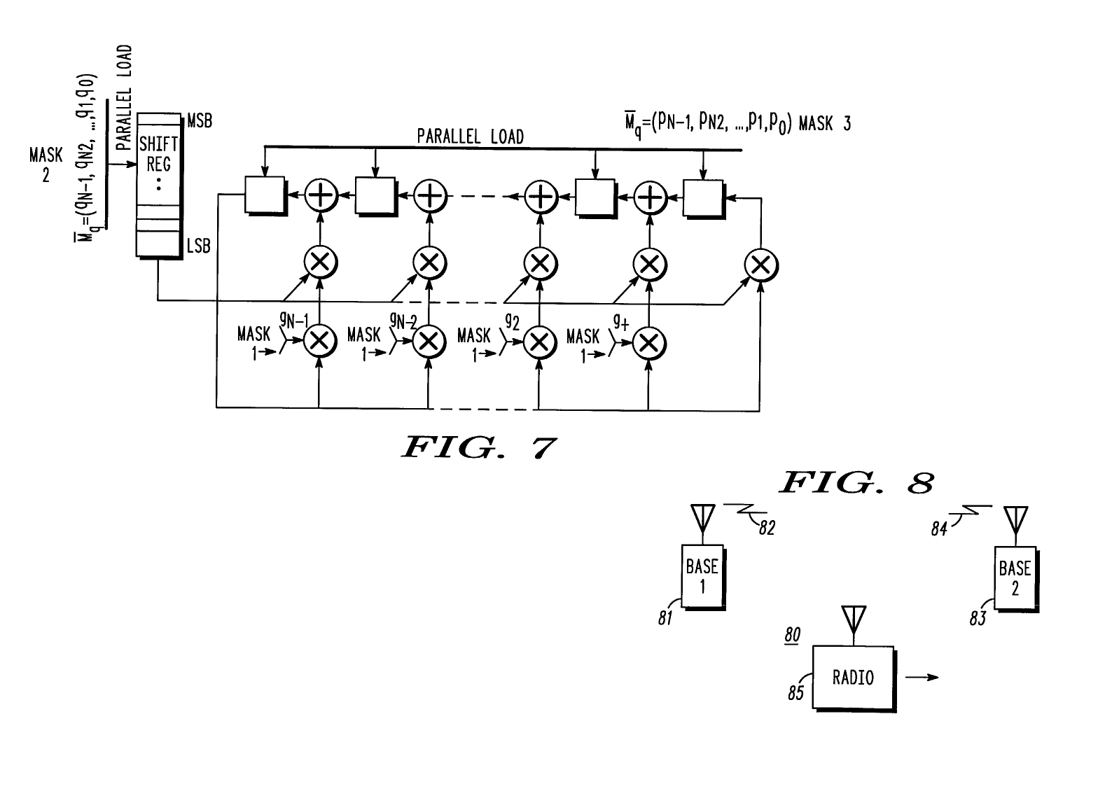

It has been shown that mask vector \vec{M}_{p+q} is a linear combination of mask vectors \vec{M}ₚ, \vec{M}ₚ₊₁, . . . , \vec{M}_{p+N-1} and the combining weights are determined by the elements of mask vector \vec{M}_{q}. FIG. 7 comprises a logical circuit depiction by which the next-state mask (mask 1) is used to combine two other masks (mask 2 and mask 3) to derive a new mask, the defining elements of which will appear in the open squares presented in the illustration. These processes are also readily implementable in a programmable computational platform such as a microprocessor.

These embodiments allow a relatively few pseudorandom sequence generating polynomials to be utilized to derive other such polynomials to thereby allow calculation of any state within a finite number of potential states for a given pseudorandom sequence of items. Memory requirements are therefore modest. Appropriate selection of these few polynomials can also result in minimized computational iterations and timely acquisition of the desired state. The process is readily implementable in hardware and yet is highly suitable for software implementations as well. As a result, various implementation platforms can be utilized to attain the benefits of these embodiments.

For example, referring to FIG. 8, a wireless communications system 80, such as a code division multiple access system, can have a first base station 81 transmitting code division multiple access radio frequency signals 82 that use a specific phase of a specific pseudorandom sequence of numbers for synchronization purposes and a second base station 83 that transmits code division multiple access radio frequency signals 84 that use a different phase of the same specific pseudorandom sequence of numbers, all in accordance with well understood prior art technique. A radio 85 that is compatibly receiving wireless signals 82 from the first base station 81 will not automatically be able to receive wireless signals 83 from the second base station 84 upon traveling within range of the second base station 83 because the synchronization pseudorandom sequence will be out of phase with the radio's 85 present settings.

By using the known offset between states of the pseudorandom sequence of numbers, however, the radio 85 can utilize any of the embodiments taught above to quickly adjust itself to the correct phase of the sequence for the second base station 83 and begin receiving signals 84 from that source. This capability can of course be rendered in hardware, software, or a combined hardware/software in the radio 85 as appropriate to the capabilities of the radio, the radio's form factor requirements, power usage limitations, and so forth.

Those skilled in the art will recognize that yet further modifications, alterations, and combinations can be made with respect to the various embodiments set forth. Such modifications, alterations, and combinations should be viewed as within the contents of these teachings and are within the spirit and scope of the invention.

We claim:

1. A method for generating a particular state of a pseudorandom sequence of items, comprising:
providing a starting state of the pseudorandom sequence of items which pseudorandom sequence of items has a corresponding finite number of potential states;
providing a first mask for generating a next state of the pseudorandom sequence of items;
identifying a desired subsequent state of the pseudorandom sequence of items;
providing a plurality of additional masks for generating corresponding subsequent states of the pseudorandom sequence of items, wherein the corresponding subsequent states are unevenly distributed throughout the finite number of potential states for the pseudorandom sequence of items;
using at least the starting state of the pseudorandom sequence of items and at least one of the plurality of additional masks to calculate the desired subsequent state of the pseudorandom sequence of items.

2. The method of claim 1 wherein providing a plurality of additional masks for generating corresponding subsequent states of the pseudorandom sequence of items, wherein the corresponding subsequent states are unevenly distributed throughout the finite number of potential states for the pseudorandom sequence of items includes providing a plurality of additional masks for generating corresponding subsequent states of the pseudorandom sequence of items, wherein the corresponding subsequent states are distributed substantially logarithmically throughout the finite number of potential states for the pseudorandom sequence of items.

3. The method of claim 1 wherein providing a plurality of additional masks comprises providing between 5 and 15 additional masks.

4. The method of claim 1 wherein identifying a desired subsequent state of the pseudorandom sequence of items comprises identifying an offset from the starting state and adding the offset to a sequential position of the starting state of the pseudorandom sequence of items.

5. A method for generating a particular state of a pseudorandom sequence of items, comprising:
providing a starting state of the pseudorandom sequence of items which pseudorandom sequence of items has a corresponding finite number of potential states;
identifying a desired subsequent state of the pseudorandom sequence of items;
moving from the starting state to the desired subsequent state by sequentially selecting interim pseudorandum sequence generating polynomials that correspond to multi-state moves of ever decreasing size until one of:
the desired subsequent state is attained; and
only next-state moves are made before attaining the desired subsequent state.

6. The method of claim 5 wherein sequentially selecting pseudorandom sequence generating polynomials includes:
providing a plurality of additional pseudorandom sequence generating polynomials for generating corresponding subsequent states of the pseudorandom sequence of items,
using at least one of the additional pseudorandom sequence generating polynomials to generate at least one of the interim pseudorandom sequence generating polynomials.

7. The method of claim 6 wherein providing a plurality of additional pseudorandom sequence generating polynomials for generating corresponding subsequent states of the pseudorandom sequence of items includes providing a plurality of additional pseudorandom sequence generating polynomials for generating corresponding subsequent states of the pseudorandom sequence of items, wherein the corresponding subsequent states are unevenly distributed throughout the finite number of potential states for the pseudorandom sequence of items.

8. A method for generating a particular state of a pseudorandom sequence of items, comprising:
providing a starting state of the pseudorandom sequence of items which pseudorandom sequence of items has a corresponding finite number of potential states and wherein each state of the pseudorandom sequence of items can be calculated by a corresponding pseudorandom sequence generating polynomial;
providing at least one pseudorandom sequence generating polynomial;
identifying a desired subsequent state of the pseudorandom sequence of items;
using at least one of the at least one pseudorandom sequence generating polynomial to generate a specific pseudorandom sequence generating polynomial that will calculate the pseudorandom sequence of items that corresponds to the desired subsequent state of the pseudorandom sequence of items;
using the specific pseudorandom sequence generating polynomial to generate the pseudorandom sequence of items that corresponds to the desired subsequent state of the pseudorandom sequence of items.

9. The method of claim 8 wherein providing at least one pseudorandom sequence generating polynomial includes providing a plurality of pseudorandom sequence generating polynomials.

10. The method of claim 9 wherein providing a plurality of pseudorandom sequence generating polynomials includes providing a plurality of pseudorandom sequence generating polynomials for generating corresponding subsequent states of the pseudorandom sequence of items, wherein the corresponding subsequent states are unevenly distributed throughout the finite number of potential states for the pseudorandom sequence of items.

11. The method of claim 8 to wherein using at least one of the at least one pseudorandom sequence generating polynomial to generate a specific pseudorandom sequence generating polynomial includes iteratively using a plurality of pseudorandom sequence generating polynomials to sequentially generate pseudorandom sequence generating polynomials to thereby generate the specific pseudorandom sequence generating polynomial.

12. A method for generating a specific pseudorandom sequence generating polynomial, comprising:
providing a starting state of a pseudorandom sequence of items which pseudorandom sequence of items has a corresponding finite number of potential states and wherein each state of the pseudorandom sequence of items can be calculated by a corresponding pseudorandom sequence generating polynomial;
providing at least one pseudorandom sequence generating polynomial;
identifying a desired subsequent state of the pseudorandom sequence of items;
using at least one of the at least one pseudorandom sequence generating polynomial to generate the specific pseudorandom sequence generating polynomial, which specific pseudorandom sequence generating polynomial will calculate the pseudorandom sequence of items that corresponds to the desired subsequent state of the pseudorandom sequence of items.

13. The method of claim 12 and further comprising using the specific pseudorandom sequence generating polynomial to generate the pseudorandom sequence of items that corresponds to the desired subsequent state of the pseudorandom sequence of items.

14. A method for generating a particular state of a pseudorandom sequence having 32,767 potential states wherein each state of the pseudorandom sequence can be calculated by a corresponding pseudorandom sequence generating polynomial, comprising:
providing a starting state of the pseudorandom sequence;
providing a first pseudorandom sequence generating polynomial that comprises a next-state pseudorandom sequence generating polynomial;
providing between 5 and 25 additional pseudorandom sequence generating polynomials for generating corresponding subsequent states of the pseudorandom sequence, wherein the corresponding subsequent states are unevenly distributed throughout the 32,767 potential states for the pseudorandom sequence of items;
iteratively using at least one of the first and additional pseudorandom sequence generating polynomials to generate a specific pseudorandom sequence generating polynomial that will calculate the pseudorandom sequence of items that corresponds to the particular state of the pseudorandom sequence;
using the specific pseudorandom sequence generating polynomial to generate the pseudorandom sequence that corresponds to the particular state of the pseudorandom sequence.

15. The method of claim 14 wherein the pseudorandom sequence comprises a pseudorandom sequence of binary digits.

16. A method for creating a pseudorandom sequence generating polynomial, comprising:
providing a starting state of a pseudorandom sequence of items, which pseudorandom sequence of items has a corresponding finite number of potential states and wherein each state of the pseudorandom sequence of items can be calculated by a corresponding pseudorandom sequence generating polynomial;
providing at least one pseudorandom sequence generating polynomial;
identifying a desired subsequent state of the pseudorandom sequence of items;
using the at least one pseudorandom sequence generating polynomial to generate a first interim pseudorandom sequence generating polynomial that can calculate a first interim pseudorandom sequence of items that corresponds to a first interim subsequent state of the pseudorandom sequence of items, which first interim subsequent state is more proximal to the desired subsequent state than the starting state.

17. The method of claim 16 and further comprising using at least the first interim pseudorandom sequence generating polynomial to generate a second interim pseudorandom sequence generating polynomial that can calculate a second interim pseudorandom sequence of items that corresponds to a second interim subsequent state of the pseudorandom sequence of items, which second interim subsequent state is more proximal to the desired subsequent state than the first interim subsequent state.

18. The method of claim 16 and further comprising using a subsequently generated pseudorandom sequence generating polynomial to generate a final pseudorandom sequence of items that corresponds to the desired subsequent state of the pseudorandom sequence of items.

19. A method for creating a pseudorandom sequence generating polynomial, comprising:
providing a starting state of a pseudorandom sequence of items, which pseudorandom sequence of items has a corresponding finite number of potential states and wherein each state of the pseudorandom sequence of items can be calculated by a corresponding pseudorandom sequence generating polynomial;
providing a plurality of pseudorandom sequence generating polynomials;
identifying a desired subsequent state of the pseudorandom sequence of items;
iteratively using at least some of the plurality of pseudorandom sequence generating polynomials to generate additional pseudorandom sequence generating polynomials that can calculate additional pseudorandom sequences of items that correspond to additional subsequent states of the pseudorandom sequence of items.

20. The method of claim 19 and further comprising using one of the additional pseudorandom sequence generating polynomials to generate a final pseudorandom sequence of items that corresponds to the desired subsequent state of the pseudorandom sequence of items.

21. The method of claim 19 and further comprising:
using one of the additional pseudorandom sequence generating polynomials to generate a pseudorandom sequence of items that corresponds to a specific subsequent state of the pseudorandom sequence of items; and
using a next-state pseudorandom sequence generating polynomial to calculate at least one next subsequent state from the specific subsequent state.

22. The method of claim 19 wherein the next subsequent state comprises the desired subsequent state of the pseudorandom sequence of items.

23. The method of claim 19 and further comprising:
using one of the additional pseudorandom sequence generating polynomials to generate a pseudorandom sequence of items that corresponds to a specific subsequent state of the pseudorandom sequence of items; and
using slewing to achieve the desired subsequent state of the pseudorandom sequence of items

24. A radio comprising:
a transceiver;
synchronization means operably coupled to the transceiver, wherein the synchronization means includes:
first means for providing a starting state of a pseudorandom sequence of numbers comprising a synchronizing data stream compatible with a first base station in a code division multiple access wireless communications system, which pseudorandom sequence of numbers has a corresponding finite number of potential states and wherein each state of the pseudorandom sequence of numbers can be calculated by a corresponding pseudorandom sequence generating polynomial;
second means for providing at least one pseudorandom sequence generating polynomial;
third means responsive to the first means for identifying a desired subsequent state of the pseudorandom sequence of numbers, which desired subsequent state comprises a synchronizing data stream compatible with a second base station in the code division multiple access wireless communications system;
fourth means responsive to the first means and the third means for using the at least one pseudorandom sequence generating polynomial to generate a first interim pseudorandom sequence generating polynomial that can calculate a first interim pseudorandom sequence of numbers that corresponds to a first interim subsequent state of the pseudorandom sequence of numbers, which first interim subsequent state is more proximal to the desired subsequent state than the starting state.
